(19) United States
(12) Patent Application Publication
(10) Pub. No.: US 2020/0038701 A1
(43) Pub. Date: Feb. 6, 2020

(54) Closed Water Mist Nozzle with Active Opening

(71) Applicant: Ningbo Lan Tai Electromechanical Equipment Co., Ltd., Ningbo (CN)

(72) Inventor: JIANQUAN LI, NINGBO (CN)

(73) Assignee: Ningbo Lan Tai Electromechanical Equipment Co., Ltd.

(21) Appl. No.: 16/281,684

(22) Filed: Feb. 21, 2019

(30) Foreign Application Priority Data
Jul. 31, 2018 (CN) 201821224581.7

(51) Int. Cl. A62C 37/14; A62C 31/02

(52) U.S. Cl. CPC A62C 37/14; A62C 99/0072; A62C 31/02

(57) ABSTRACT

The present disclosure discloses a closed water mist nozzle with active opening, comprising a nozzle body (1) and a sensitive part provided on the nozzle body (1), and a starting element for changing the state of the sensitive part is further arranged on the nozzle body (1); the starting element can be used for heating or impacting the sensitive part to make the sensitive part crack or fall off; the sensitive part is a fusible alloy column or a temperature-sensing glass bulb; the material of fusible alloy column is bismuth-tin alloy; the closed water mist nozzle with active opening of the present disclosure can be actively controlled by controlling the breakage of the temperature-sensing glass ball, which is of a wider application prospect.

### CROSS-REFERENCE TO RELATED APPLICATIONS

This application claims priority to Chinese Patent Application No. 201821224581.7 with a filing date of Jul. 31, 2018. The content of the aforementioned application, including any intervening amendments thereto, are incorporated herein by reference.

### TECHNICAL FIELD

The present disclosure relates to the technical field of fire extinguishing system, in particular to a closed water mist nozzle with active opening.

### BACKGROUND

A closed water mist nozzle belongs to one of the spray heads of automatic water spray in the fire extinguishing system, and is provided with a temperature-sensing glass ball. The temperature-sensing glass ball is a hollow cylinder made of glass, and the hollow part of the cylinder is sealed with a liquid prone to thermal expansion. The temperature-sensing glass ball is embedded into the water supply valve of the closed water mist nozzle, for sealing the fire-fighting water supply pipeline connected with the water supply valve. When the temperature-sensing glass ball is broken by the thermal expansion of the liquid inside, the water supply valve is opened to enable the water to be sprayed outwards through the closed water mist nozzle, so that the automatic fire extinguishing function is achieved.

The existing closed water mist nozzle relies on the passive rupture of the temperature-sensing glass ball subjected to the heat influence to open the injection valve, and the temperature-sensing glass ball needs to be broken in a high-temperature region close to the fire source to ensure the open of the injecting water mist. The fire cannot be sensed in time when the temperature-sensing glass ball is relatively far away from the fire source, and there are limited opening times of the nozzle, with poor fire extinguishing effect.

### SUMMARY

One objective of the present disclosure is to overcome the shortcomings of the prior arts by providing a closed water mist nozzle with active opening.

The technical solution of the present disclosure is as follows: a closed water mist nozzle with active opening, comprising a nozzle body and a sensitive part provided on the nozzle body, and a starting element for changing the state of the sensitive part is further arranged on the nozzle body.

In one embodiment, the starting element can be used for heating or impacting the sensitive part to make the sensitive part crack or fall off.

In one embodiment, the sensitive part is a fusible alloy column or a temperature-sensing glass bulb.
In one embodiment, the material of fusible alloy column is bismuth-tin alloy.

In one embodiment, the temperature-sensing glass bulb is a hollow cylindrical glass bulb filled with liquid prone to thermal expansion.

In one embodiment, the starting element is an electric heating element used for heating the temperature-sensing glass bulb until the temperature-sensing glass bulb breaks.

In one embodiment, the closed water mist nozzle with active opening, comprises a nozzle body and a temperature-sensing glass ball provided on the nozzle body; a water pipe joint is arranged at the top of the nozzle body for being connected with the water supply pipe; a cavity is formed inside the nozzle body; a plurality of fine water mist spouts connected with the cavity are provided in the side wall of the nozzle body in the circumferential direction; a water inlet hole connected with the water pipe joint is provided in the top wall of the cavity; a valve ejector rod is arranged in the cavity; the upper end of the valve ejector rod is used for blocking the water inlet hole, and the lower end penetrates through the bottom of the cavity; a mounting base for fixing the temperature-sensing glass ball is arranged at the bottom end of the nozzle body; the lower end of the temperature-sensing glass ball is fixed with the mounting base, and the upper end presses against the lower end of the valve ejector rod; a sealing ring for sealing the water inlet hole is arranged on the upper end of the valve ejector rod and a flange is arranged on the side wall of the middle part of the valve ejector rod, and a compression spring is arranged between the flange and the top wall of the cavity; an electric heating wire is wound on the temperature-sensing glass ball, and an electrode is led out.

One of the advantages of the present disclosure is that the opening of the closed water mist nozzle can be actively controlled by controlling the breakage of the temperature-sensing glass ball, which is of a wider application prospect.

### BRIEF DESCRIPTION OF THE DRAWINGS

The skilled in the art would more profoundly understand the technical solution of the present disclosure upon reading the following embodiment with reference taken to the accompanying drawings, in which:

FIG. 1 is a semi-sectional structural schematic diagram of the closed water mist nozzle with active opening of the present disclosure.

FIG. 2 is a bottom view structural schematic diagram of the closed water mist nozzle with active opening of the present disclosure.

FIG. 3 is a structural schematic diagram of the closed water mist nozzle with active opening of the present disclosure.

### DETAILED DESCRIPTION

Various aspects of the illustrative embodiments of the present disclosure will be described herein using terms commonly employed by those skilled in the art. Alternate embodiments may be practiced by the skilled in the art under the scope and the principle of the disclosed embodiments.

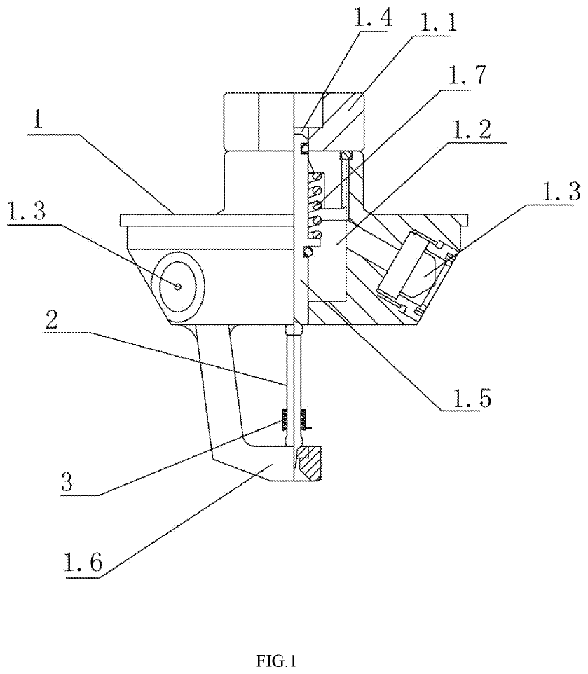

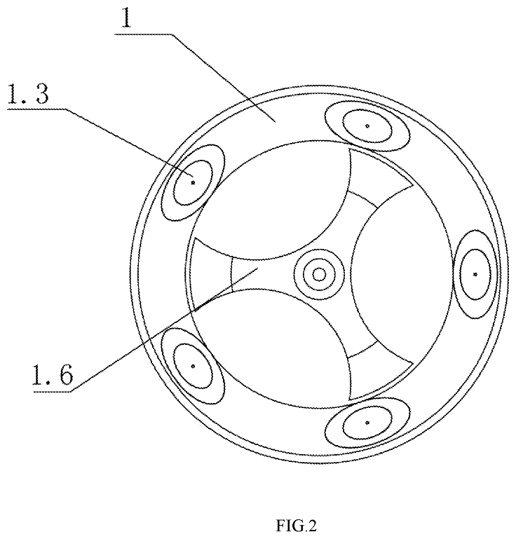

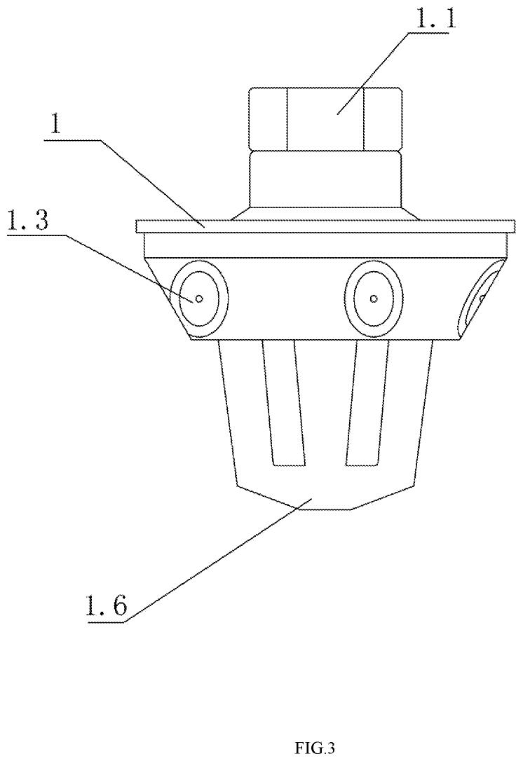

As shown in FIGS. 1-3, a closed water mist nozzle with active opening, comprises a nozzle body 1 and a temperature-sensing glass ball 2 provided on the nozzle body 1, and the temperature-sensing glass ball 2 is a hollow cylindrical glass bulb filled with liquid prone to thermal expansion; a water pipe joint 1.1 is arranged at the top of the nozzle body 1 for being connected with the water supply pipe; a cavity 1.2 is formed inside the nozzle body 1; a plurality of fine water mist spouts 1.3 connected with the cavity 1.2 are provided in the side wall of the nozzle body 1 in the circumferential direction; a water inlet hole 1.4 connected with the water pipe joint 1.1 is provided in the top wall of the cavity 1.2; a valve ejector rod 1.5 is arranged in the cavity 1.2; the upper end of the valve ejector rod 1.5 is used for blocking the water inlet hole 1.4, and the lower end penetrates through the via hole at the bottom of the cavity 1.2; a mounting base 1.6 for fixing the temperature-sensing glass ball 2 is arranged at the bottom end of the nozzle body 1; the lower end of the temperature-sensing glass ball 2 is fixed with the mounting base 1.6, and the upper end presses against the lower end of the valve ejector rod 1.5; a sealing ring for sealing the water inlet hole 1.4 is arranged on the upper end of the valve ejector rod 1.5, and a flange is arranged on the side wall of the middle part of the valve ejector rod 1.5; on the lower side of the flange of the valve ejector rod 1.5 is provided with a sealing ring, in order to seal the via hole at the bottom of the cavity 1.2 when the valve ejector rod 1.5 moves downwards; a compression spring 1.7 is arranged between the flange and the top wall of the cavity 1.2; the function of the compression spring 1.7 is to provide a pre-press force for separating the upper end of the valve ejector rod 1.5 from the water inlet hole 1.4; the natural length of the compression spring 1.7 is larger than the height of the cavity 1.2; an electric heating wire 3 is wound on the temperature-sensing glass ball 2, and an electrode is led out so as to be electrified and controlled.

The invention is only a characteristic implementation example of the present utility model, and is not limited to the protection scope of the present utility model. According to the technical scheme, the technical scheme is formed by adopting equivalent exchange or equivalent replacement, and falls within the protection scope of the novel practical application.

Although certain embodiments have been illustrated and described herein for purposes of description, a wide variety of alternate and/or equivalent embodiments or implementations to achieve the same purposes may be substituted for the embodiments shown and described without departing from the scope of the present disclosure. This application is intended to cover any adaptations or variations of the embodiments discussed herein.

I claims:

1. A closed water mist nozzle with active opening, comprising a nozzle body (1) and a sensitive part provided on the nozzle body (1), and a starting element for changing the state of the sensitive part is further arranged on the nozzle body (1).

2. The closed water mist nozzle with active opening of claim 1, wherein the starting element can be used for heating or impacting the sensitive part to make the sensitive part crack or fall off.

3. The closed water mist nozzle with active opening of claim 2, wherein the sensitive part is a fusible alloy column or a temperature-sensing glass bulb.

4. The closed water mist nozzle with active opening of claim 3, wherein the material of fusible alloy column is bismuth-tin alloy.

5. The closed water mist nozzle with active opening of claim 3, wherein the temperature-sensing glass bulb is a hollow cylindrical glass bulb filled with liquid prone to thermal expansion.

6. The closed water mist nozzle with active opening of claim 5, wherein the starting element is an electric heating element used for heating the temperature-sensing glass bulb until the temperature-sensing glass bulb breaks.

7. The closed water mist nozzle with active opening of claim 6, wherein it comprises a nozzle body (1) and a temperature-sensing glass ball (2) provided on the nozzle body (1); a water pipe joint (1.1) is arranged at the top of the nozzle body (1) for being connected with the water supply pipe; a cavity (1.2) is formed inside the nozzle body (1); a plurality of fine water mist spouts (1.3) connected with the cavity (1.2) are provided in the side wall of the nozzle body (1) in the circumferential direction; a water inlet hole (1.4) connected with the water pipe joint (1.1) is provided in the top wall of the cavity (1.2); a valve ejector rod (1.5) is arranged in the cavity (1.2); the upper end of the valve ejector rod (1.5) is used for blocking the water inlet hole (1.4), and the lower end penetrates through the bottom of the cavity (1.2); a mounting base (1.6) for fixing the temperature-sensing glass ball (2) is arranged at the bottom end of the nozzle body (1); the lower end of the temperature-sensing glass ball (2) is fixed with the mounting base (1.6), and the upper end presses against the lower end of the valve ejector rod (1.5); a sealing ring for sealing the water inlet hole (1.4) is arranged on the upper end of the valve ejector rod (1.5) and a flange is arranged on the side wall of the middle part of the valve ejector rod (1.5), and a compression spring (1.7) is arranged between the flange and the top wall of the cavity (1.2); an electric heating wire (3) is wound on the temperature-sensing glass ball (2), and an electrode is led out.
